(19) United States
(12) Patent Application Publication
(10) Pub. No.: US 2026/0165308 A1
(43) Pub. Date: Jun. 18, 2026

(54) WEIGHTED HORSESHOE

(71) Applicants: Brian Roy Skotty, Elmhurst, IL (US); Ryan Jacob Skotty, Elmhurst, IL (US); Kailee Marie Skotty, Austin, TX (US); Michael David Skotty, Kingsport, TN (US); Kaitlyn Marie Skotty, Kingsport, TN (US); David Skotty, Kingsport, TN (US)

(72) Inventors: Brian Roy Skotty, Elmhurst, IL (US); Ryan Jacob Skotty, Elmhurst, IL (US); Kailee Marie Skotty, Austin, TX (US); Michael David Skotty, Kingsport, TN (US); Kaitlyn Marie Skotty, Kingsport, TN (US); David Skotty, Kingsport, TN (US)

(21) Appl. No.: 19/418,390

(22) Filed: Dec. 12, 2025

Related U.S. Application Data
(60) Provisional application No. 63/733,850, filed on Dec. 13, 2024.

(51) Int. Cl. A01L 1/04

(52) U.S. Cl. CPC A01L 1/04

(57) ABSTRACT

A weighted horseshoe including a shell comprised of a first metallic material and an internal insert comprised of a second material, wherein the internal insert is situated inside of the shell.

### CROSS-REFERENCE TO RELATED APPLICATION

This application claims priority to and the benefit of U.S. Provisional Application No. 63/733,850, filed on Dec. 13, 2024, the entirety of which is hereby fully incorporated by reference herein.

### TECHNICAL FIELD

This disclosure relates generally to equine farriery, and more specifically to weighted horseshoes for performance horses. In particular, the invention relates to magnetic, heavy weighted horseshoes intended for walking competitions such as, e.g., the Tennessee Walking Horse performance competition and similar events where precise weight, weight distribution, and adjustability in a ferromagnetic horseshoe are required.

### BACKGROUND

In many equestrian performance events, such as those governed by the Tennessee Walking Horse Breeders & Exhibitors Association (TWHBEA), trainers and farriers use pads or heavily weighted horseshoes to influence horse gait. The TWHBEA provides rules for shoeing competition horses in different classes and events. In specific classes, horses are judged on how accentuated and smooth the gait of the horse is. To encourage the horse to lift its feet higher and accentuate its gait, the trainer will use often pads placed under the horse's front feet or weigh down the horse's feet with heavy horseshoes. If weighted shoes are used, the size of the horseshoes are governed by the rules of the TWHBEA. Weighted shoes are used to increase the height the horse raises its feet, but also to balance the horse's stride so that it raises its front feet to the same height. Varying the weight of each horseshoe can often correct any variations or anomalies in the horse's gait.

Existing practice for weighted horseshoes often relies on fabricating horseshoes from sintered tungsten heavy alloy or similar dense materials, resulting in shoes that maximize mass while conforming to TWHBEA size rules. These weighted shoes elevate hoof action and can help balance the horse's stride. However, the regulatory environment is in flux. Hoof pads are scheduled for a ban effective in 2025 under anticipated USDA rulemaking, and solid tungsten shoes are increasingly proscribed from competitions requiring steel shoes, as verified by magnet testing.

Alongside regulatory hurdles, the available technology faces substantial cost and usability issues. Solid tungsten shoes are expensive, commonly costing $4,000 to $6,000 per pair, are difficult to repair, and must often be replaced due to cracking or other failures. Existing solutions also do not offer practical means for minor adjustments to shoe weight, which are critical for balancing a horse's gait. Changes of only a few ounces can alter performance outcomes dramatically, yet current shoes do not support this level of adjustability. Tungsten alloys themselves are prone to brittleness, further reducing shoe longevity. Field switching of shoe components or weight is not feasible using the current state-of-the-art, limiting customization for individual horses. These deficiencies highlight a need for a more robust, cost-effective, adjustable, and regulatory-compliant solution for weighted horseshoes.

### SUMMARY

An object of the present disclosure is to provide a weighted horseshoe that is durable and easily adjustable. Another object is to provide a system and method to manufacture weighted horseshoes. An embodiment of the present disclosure provides a weighted horseshoe that includes a magnetic steel shell for regulatory compliance and an internal high-density insert offering superior weight and mass. The steel shell ensures pass-through of competition magnet tests and offers the mechanical durability of traditional steel shoes. In various embodiments, one or more inserts, composed of sintered tungsten heavy alloy or depleted uranium, for example, are encapsulated within the shell and may be arranged as single or multiple segments to permit targeted distribution of weight across the shoe, such as toe, heel, or side bias. Mechanical attachment, adhesive bonding, or welding, for example, may be employed to secure the insert or inserts in place.

A feature of the horseshoe may also include pockets or openings in the shell capable of housing removable slugs made from tungsten, steel, or other metals. This feature enables fine adjustment of overall weight and its distribution, facilitating on-the-fly configuration changes for training or during a performance season. Further, sockets can be provided for the installation of removable hardened steel or tungsten carbide traction studs to enhance horse safety on hard surfaces including concrete or blacktop.

Various manufacturing methods for the horseshoe are disclosed within, details of which are provided below. For example, certain embodiments encapsulate compressed tungsten powder within the shell. Others use direct over-molding or three-dimensional printed inserts to reduce manufacturing cost and complexity. This design approach enables the horseshoe to deliver modularity in weight configuration, compliance with steel-shoe competition requirements, and improved durability and cost.

The ability to precisely set both absolute and distributed shoe mass affords farriers and trainers new flexibility in balancing each horse's gait according to individual need and rule compliance. The improved design directly solves the cost, regulatory, and performance problems of heavy competition horseshoes.

### BRIEF DESCRIPTION OF THE DRAWINGS

FIG. 1 depicts an example of an assembled weighted horseshoe having several inserts placed within a shell, in accordance with various embodiments.

FIG. 2 depicts an exploded view of an example of a weighted horseshoe having several segments inserted within a shell, in accordance with various embodiments.

FIG. 3 depicts an example of a finished product of an assembled weighted horseshoe that has been sanded and coated to create the finished product, in accordance with various embodiments.

FIG. 4 depicts an exploded view of an example of a weighted horseshoe where the shell is filled with powder to add the desired weight and then covered with a top cover to contain the powder within, in accordance with various embodiments.

FIG. 5 depicts an example of a stud and slug feature that can be used on various embodiments to adjust the weight of the weighted horseshoe, in accordance with various embodiments.

FIG. 6 shows a close-up image of the example stud feature having a traction element, in accordance with various embodiments.

FIG. 7 depicts an example of a traction feature that can be added to portions of the weighted horseshoe to enhance traction and increase wear resistance on ground contact surfaces, in accordance with various embodiments.

FIG. 8 depicts an example of a weighted horseshoe having an unbalanced design having a pocket for placing weight in the back or the front of the horseshoe, in accordance with various embodiments.

FIG. 9 shows an overlay of different profiles that may be used in fabricating the weighted horseshoe, in accordance with various embodiments.

FIGS. 10A, 10B, 10C, 10D, 10E, and 10F show different profiles that may be used in fabricating the weighted horseshoe, in accordance with various embodiments.

### DETAILED DESCRIPTION

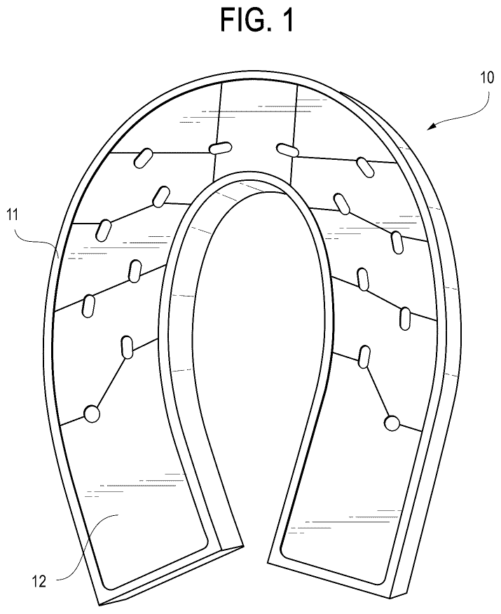

With reference to the figures, FIG. 1 shows an example of a weighted horseshoe 10 comprising a shell 11 that forms the exterior body for structural strength and regulatory compliance. The shell 11 may include, for example, a bottom surface and a plurality of side surfaces that together form a cavity within the shell 11. The shell may be made of ferromagnetic steel specifically designed to pass the widely used “magnet test” standard. At least one insert 12 (and typically a plurality of inserts 12) of high-density material is fitted and enclosed within the steel shell. Such insert material may be, for example, a sintered tungsten heavy alloy, depleted uranium, or another suitable high-density metal. In various examples of the construction, the inserts 12 may be machined or otherwise processed from plate or other bulk stock to geometrically conform with the shell 11 and to provide passage for nails and other required profiles. In other examples, the inserts 12 may be 3D printed from Tungsten Alloys or other materials to create the plurality of inserts 12, or one single insert 12 that fills the cavity within the shell 11. Multiple inserts 12 may be utilized and distributed at specific portions of the shoe to enable toe-or heel-heavy or side-biased weighting as required by performance objectives or particular horses.

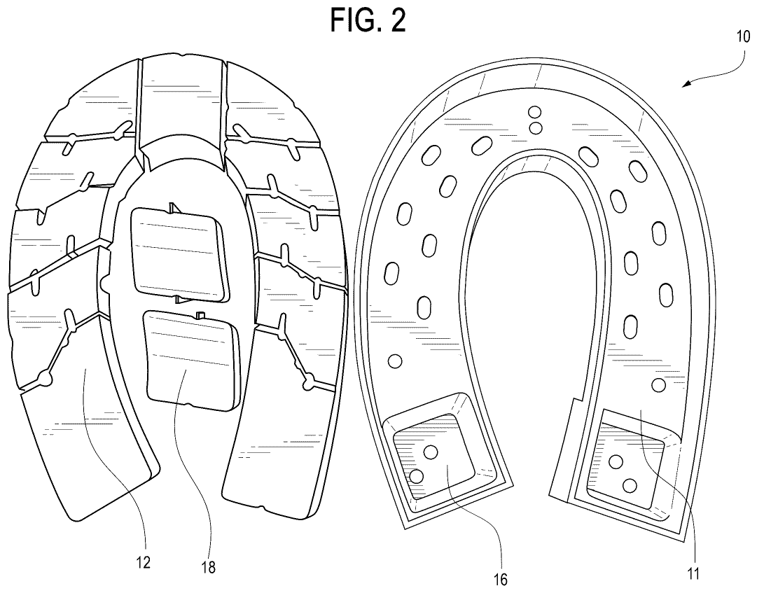

FIG. 2 shows another example of the weighted horseshoe 10 in an exploded view. In FIG. 2, the shell 11 is shown before the at least one insert 12 has been inserted therein. The insert 12 or inserts 12 may be bonded to the shell 11 through suitable methods such as the use of high-strength epoxy or adhesive, direct welding, or brazing.

In various examples, the shell 11 may include pockets 16 within the heel portion of the horseshoe 10. In such an example, heel inserts 18 may be inserted first into the pockets 16 of the shell 11, and the remainder of the inserts 12 may then be inserted into the shell over the heel inserts 18, thereby forming two layers of insert material within the heel portion of the shell 11. Alternatively, a single piece heel insert 18 may be utilized that spans the entire height of the shell 11 in the region of the pocket 16. Similarly still, a singular machined insert 12 that fills the entirety of the inner portion of the shell 11 may also be used. The weight in the heel portion in and around the pocket 16 may be tuned to the particular training needs and goals of a particular horse.

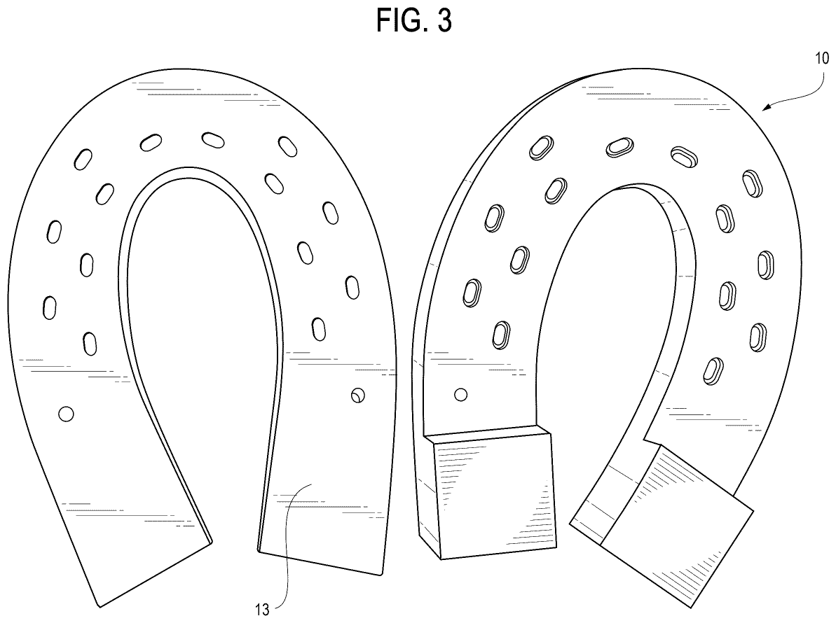

FIG. 3 depicts an example of a finished product in accordance with various embodiments. In certain variants, the shell 11 and inserts 12 are over-molded with a high-strength coating 13, such as a polymer and/or a powder coating. In some examples, the high-strength coating 13 may also form the external shoe geometry and retain the heavy inserts. For example, the inserts 12 may be overcoated with such a high-strength polymer coating 13 to create the shell and to retain the inserts therein. In still other approaches, steel plates may be welded to the outer perimeter of the segment inserts 12, providing increased impact durability. After assembly, the shoe is finished per competition requirements, such as by sanding and painting or powder-coating to ensure corrosion resistance and a professional finish. FIG. 3 shows such a finished product with the coating 13.

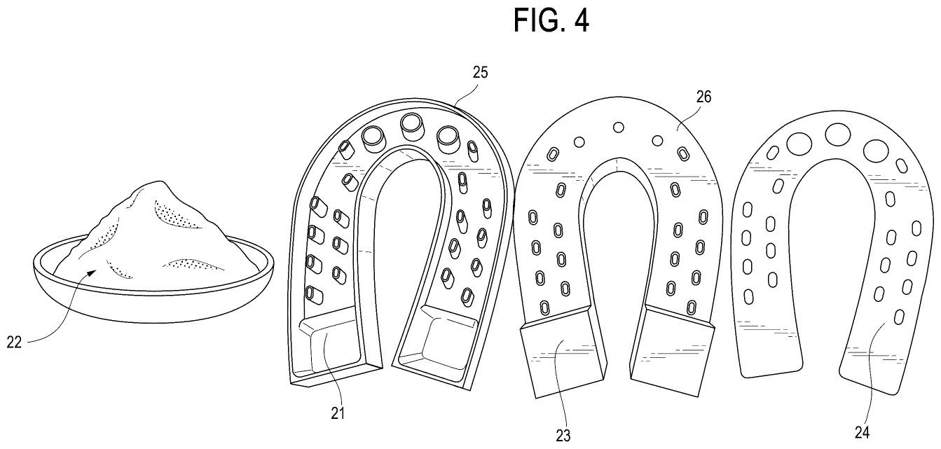

FIG. 4 depicts an alternative embodiment of the weighted horseshoe 10. In this alternative embodiment, the weighted horseshoe 10 is formed by filling a cavity 21 formed within the shell 25 with powder 22, for example compressed tungsten powder (e.g., 99.9%). The powder 22 may be in various spherical particle sizes to maximize compaction and density under pressure. The shell 25 is constructed to receive and compact the powder 22 of high purity to maximize fill density. After the powder 22 is loaded into the shell, it is compressed under high pressure to add weight to the horseshoe 10. The shell 25 has bottom side 23 in which nail holes 26 are formed by standoffs that are formed and pass through the interior cavity 21 of the shell 25 to both secure the horseshoe 10 to the hoof and to seal the powder 22 within the shell. A cover 24 may be welded or adhesively affixed to the shell 25 to entirely encapsulate the compressed powder 22 weight material, ensuring no loss during installation or use. The cover 24 may likewise include holes that match with the nail holes 26 in the shell 25 to allow the nails to pass through the cover into the hoof.

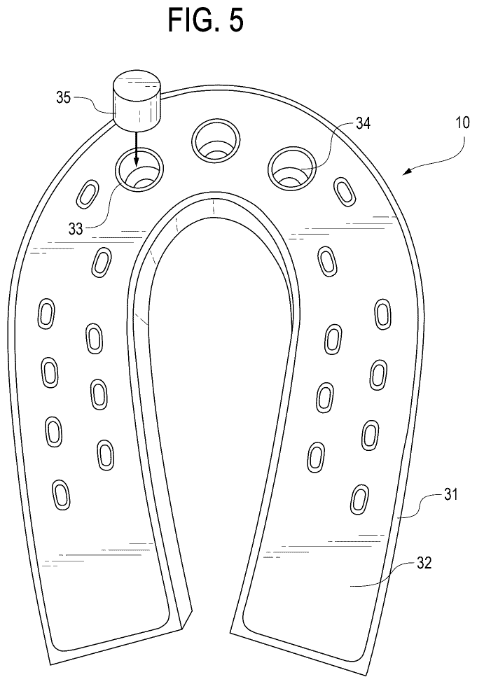

FIG. 5 depicts a feature that permits tunable performance. The shell 31 may be provided with pockets or machined openings 33 that have a hollow interior 34 that can receive removable slugs 35 of varying material and density, including tungsten, steel, or even aluminum. Changing the position or presence of these slugs 35 allows the farrier or trainer to tailor not only the horseshoe's 10 total mass, but also its distribution from heel-to-toe or across the width of the horseshoe 10, achieving the necessary performance or comfort for each horse. Additional threaded or interference-fit sockets may accommodate removable traction studs, typically of hardened steel or tungsten carbide, which are inserted or withdrawn based on competition or transport surface conditions. A cover 32 may be sealed to the shell 31, forming a sealed joint between the two elements, to thereby encapsulate either the powder 22 or the inserts 12 within the shell 31. The sealed joint between the shell 31 and the cover 32 may be welded or bonded, or any other suitable seam.

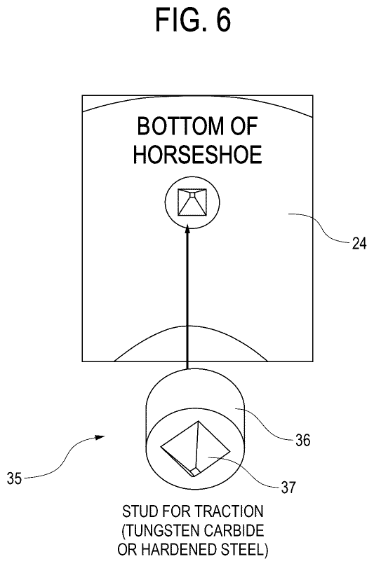

FIG. 6 depicts a traction feature that may be added to the slug 35 in various embodiments. The slug 35 may comprise a base 36 and a stud 37 made of tungsten carbide or hardened steel, for example. This feature provides traction for the weighted horseshoe on hard surfaces and may be used with any embodiment.

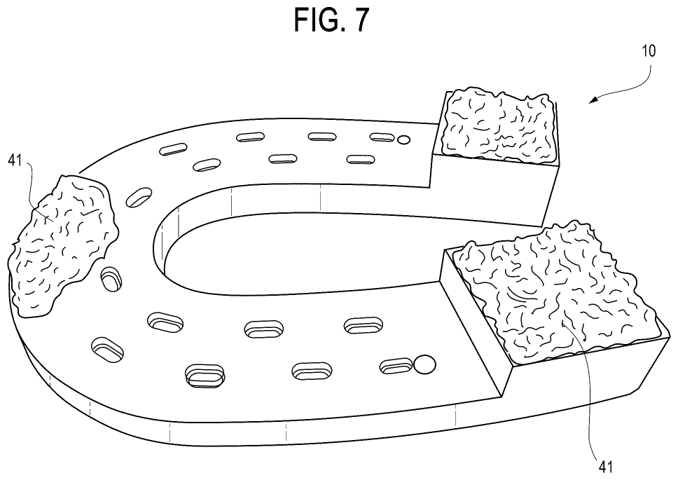

FIG. 7 depicts another type of traction feature that may be added to the weighted horseshoe 10. Traction features 41, such as Drill Tec or Borium, or other modifications, may be added to the front and/or rear of the weighted horseshoe, e.g., by adhesion, welding, or other known methods. This feature can create a rough, uneven surface that enhances traction and increase wear resistance on ground contact surfaces.

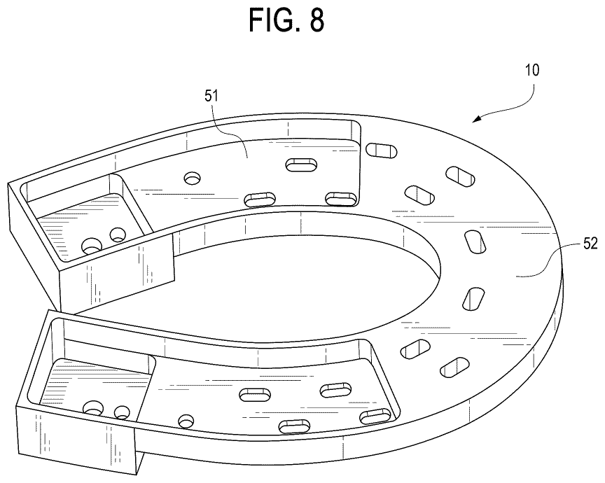

FIG. 8 shows an embodiment of the weighted horseshoe that utilizes either a heavy toe or heavy heel design. FIG. 8 depicts the heavy heel design that has a pocket 51 in the heel that may be filled with weighted material using the methods described above, for example. Alternatively, the insert for the pocket 51 may be 3D printed from Tungsten Alloys and/or other materials to add weight and be designed to create one single insert that fills the pocket 51 and is bonded to the shell 11. The weight would be added to the pocket 51 in the heel, creating an unbalanced design. The front portion 52 may be made of lighter material, such as solid steel, to create a lighter toe. In a different approach, the pocket 51 may alternatively be located in the front to add weight only to the front of the horseshoe 10.

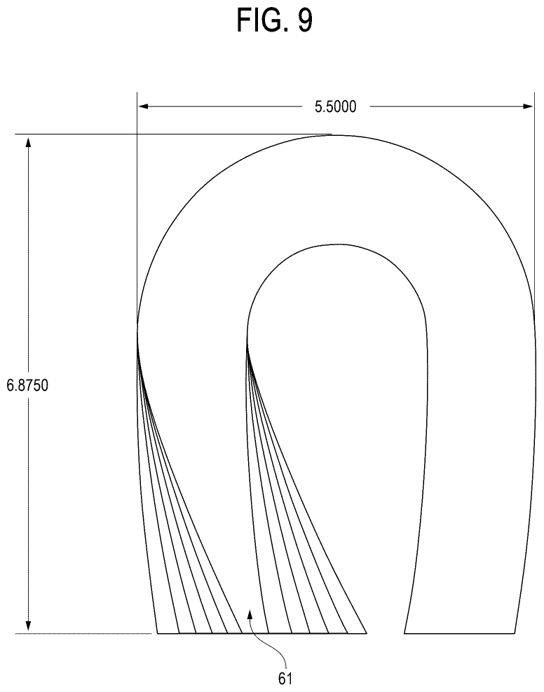

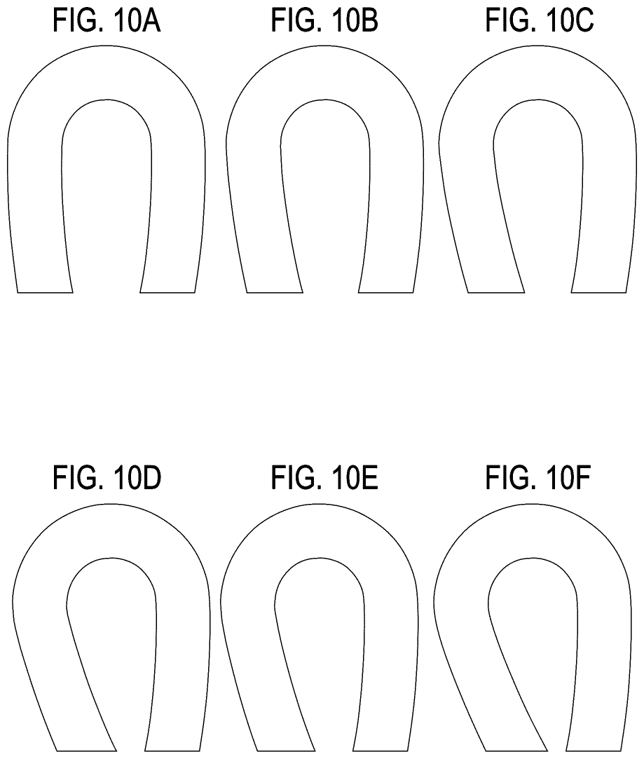

Horseshoes are typically fabricated in a range of profiles and sizes as required by competitive classes and farrier convention. The horseshoe's geometry features—such as parallel heel edges—are specifically retained to maximize total allowable mass under prevailing competition rules while maintaining the ability for field adjustment. FIG. 9 depicts different profiles and example measurements that may be used in forming the weighted horseshoe. FIG. 9 shows that a first end of the horseshoe profile may remain consistent while the second end 61 may be adjusted to fit the desired hoof profile shape. FIGS. 10A-10F show different profiles that may be formed. However, the profiles are not limited to the ones depicted in the figures.

In addition to the preferred embodiments herein described, alternative approaches may include the continued use of hoof pads (though their use is likely to be banned), monolithic solid tungsten horseshoes (with their attendant cost, durability, and compliance issues), or shoes constructed from welded-together steel and tungsten segments of variable geometry. It is contemplated that non-steel shells or the use of advanced polymer encapsulation could be utilized in applications not limited by magnet test compliance. Furthermore, insert or shell assembly methods such as casting, over-molding, or direct sintering may also be substituted for the manufacturing steps described above.

The disclosed horseshoe introduces a new combination of a compliant magnetic steel shell fully encapsulating one or more modular, high-density insert segments or heavy material powder, while providing a broad variety of options for field adjustment of weight and addition of traction elements. This design enables the most precise and humane bespoke adjustment of horseshoe weight and balance available to date, incorporates compliance with regulatory rules (including the magnet test), and allows for scalable, economical production.

The present disclosure confers several significant advantages over prior art. Its steel shell offers enhanced durability and protection against cracking compared to solid tungsten designs. The use of discrete inserts or fillable cavities enables the precise setting and balancing of shoe weight both during manufacture and in the field. The modular pocket design supports rapid installation or removal of weight or traction elements without the need for specialized tools. Utilizing only as much high-density material as needed reduces cost while maintaining or exceeding required performance. The steel shell ensures event eligibility, especially in competitions using magnet test standards. The design also improves manufacturability, scaling readily to various horse sizes and event needs, and its more humane configuration improves horse comfort through better customization and reduced reliance on now-banned pads.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims. One skilled in the art will realize that a virtually unlimited number of variations to the above descriptions are possible, and that the examples and the accompanying figures are merely to illustrate one or more examples of implementations. It will be understood by those skilled in the art that various other modifications can be made, and equivalents can be substituted, without departing from claimed subject matter. Additionally, many modifications can be made to adapt a particular situation to the teachings of claimed subject matter without departing from the central concept described herein. Therefore, it is intended that claimed subject matter not be limited to the particular embodiments disclosed, but that such claimed subject matter can also include all embodiments falling within the scope of the appended claims, and equivalents thereof.

In the detailed description above, numerous specific details are set forth to provide a thorough understanding of claimed subject matter. However, it will be understood by those skilled in the art that claimed subject matter can be practiced without these specific details. In other instances, methods, devices, or systems that would be known by one of ordinary skill have not been described in detail so as not to obscure claimed subject matter.

Various implementations have been specifically described. However, many other implementations are also possible.

What is claimed is:

1. A weighted horseshoe comprising:
a shell comprised of a first metallic material; and
an internal insert comprised of a second material, wherein the internal insert is situated inside of the shell.

2. The weighted horseshoe of claim 1, wherein the first metallic material is steel.

3. The weighted horseshoe of claim 1, wherein the first metallic material is magnetic.

4. The weighted horseshoe of claim 1, wherein the second material is tungsten.

5. The weighted horseshoe of claim 1, wherein the second material is a metallic powder.

6. The weighted horseshoe of claim 5, wherein the metallic powder is sintered tungsten powder.

7. The weighted horseshoe of claim 1, wherein the second material is depleted uranium.

8. The weighted horseshoe of claim 1, wherein the second material is denser than the first metallic material.

9. The weighted horseshoe of claim 1, wherein the internal insert comprises a plurality of segments that are housed within the shell.

10. The weighted horseshoe of claim 1, comprising at least one opening in the shell configured to receive at least one stud or slug therein.

11. The weighted horseshoe of claim 1, comprising a plurality of studs or slugs inserted into corresponding openings in the shell.

12. The weighted horseshoe of claim 1, wherein a distribution of the internal insert within the shell is higher at a first end of the shell as compared to a second end of the shell.

13. The weighted horseshoe of claim 1, wherein the internal insert is situated within a pocket formed inside of the shell, wherein the pocket is located only at one end of the shell.

14. The weighted horseshoe of claim 1, comprising a third metallic material, wherein the third metallic material is added to a front or a rear of the horseshoe, and wherein the third metallic material forms a rough, uneven surface.

15. The weighted horseshoe of claim 1, comprising a top cover applied over the internal insert and bonded to the shell.

16. The weighted horseshoe of claim 1, wherein the shell comprises a plurality of standoffs within an inside of the shell and configured to receive nails therethrough for affixing the weighted horseshoe to a hoof.

17. A weighted horseshoe comprising:
a shell comprised of a first metallic material; and
a plurality of insert segments comprised of a second material, wherein the plurality of insert segments are situated inside of the shell to fill an interior of the shell.

18. The weighted horseshoe of claim 17, wherein the plurality of insert segments are bonded to both the shell and to each other.

19. The weighted horseshoe of claim 17, wherein each of the plurality of insert segments comprises a flat plate bonded to it made of the first metallic material.

20. A weighted horseshoe comprising:
a shell comprised of a first metallic material and forming an internal cavity;
a metallic weighted powder filling the internal cavity within the shell; and
a cover attached to the shell and configured to seal the metallic weighted powder within the internal cavity of the shell.
